(19) United States
(12) Patent Application Publication
(10) Pub. No.: US 2015/0221943 A1
(43) Pub. Date: Aug. 6, 2015

(54) POSITIVE ELECTRODE FOR NONAQUEOUS ELECTROLYTE SECONDARY BATTERIES, AND NONAQUEOUS ELECTROLYTE SECONDARY BATTERY

(71) Applicant: SANYO Electric Co., Ltd., Daito-shi, Osaka (JP)

(72) Inventors: Tsutomu Nishioka, Osaka (JP); Hidekazu Hiratsuka, Osaka (JP); Masaru Watanabe, Hyogo (JP); Tatsuhiko Suzuki, Osaka (JP)

(73) Assignee: SANYO Electric CO., Ltd., Daito-shi, Osaka (JP)

(21) Appl. No.: 14/423,528

(22) PCT Filed: Mar. 6, 2014
(86) PCT No.: PCT/JP2014/001244

§ 371 Date: Feb. 24, 2015

(30) Foreign Application Priority Data
Mar. 26, 2013 (JP) 2013-063585

(51) Int. Cl. H01M 4/525; H01M 4/505; H01M 10/04; H01M 10/0525; H01M 10/0587; H01M 4/66; H01M 4/131

(52) U.S. Cl. CPC H01M 4/525; H01M 4/661; H01M 4/505; H01M 4/131; H01M 10/0525; H01M 10/0587; H01M 10/0431

(57) ABSTRACT

An advantage of the present invention is to provide a positive electrode for a non-aqueous electrolyte secondary battery causing hardly any particle breakage even in the case of an enhanced packing density of a positive electrode active material, and thereby being capable of accomplishing good cycle characteristics. A positive electrode 12 constituting a non-aqueous electrolyte secondary battery 10 of the present invention comprises a positive electrode current collector 30 having a Young's modulus of 6.5 N/mm² or less, and a positive electrode active material layer 31 formed on the current collector and comprising a positive electrode active material particle 32 of which a single particle has a compression breakage strength of 200 MPa or more.

### TECHNICAL FIELD

The present invention relates to a positive electrode for a non-aqueous electrolyte secondary battery and a non-aqueous electrolyte secondary battery.

### BACKGROUND ART

A positive electrode active material for use in a non-aqueous electrolyte secondary battery may break due to volume change accompanying charge and discharge (so-called particle breakage may occur) in some cases. In addition, an active material layer applied on a current collector is rolled in order to enhance a packing density of the positive electrode active material in the positive electrode, and the particle breakage may occur also at this time. The occurrence of particle breakage results in deterioration in performance of the non-aqueous electrolyte secondary battery, such as degradation of cycle characteristics thereof.

Accordingly, there have been proposed methods to increase compression breakage strength of the active material particle to suppress the particle breakage. Patent Literature 1, for example, discloses a positive electrode using a positive electrode active material having an average particle diameter (D₅₀) from 3 μm to 12 μm, a specific surface area from 0.2 m²/g to 1.0 m²/g, a bulk density of 2.1 g/cm³ or more, and not showing an inflection point up to 3 ton/cm² in the volume decrease rate by the Cooper Plot method.

### CITATION LIST

### Patent Literature

### Patent Literature 1: Japanese Patent Laid-Open Publication No. 2004-355824

### SUMMARY OF INVENTION

### Technical Problem

Incidentally, recent years, it has been required to further enhance a packing density of the positive electrode active material in the positive electrode. Although it is effective to increase the applying pressure at the time of the above-described rolling (e.g., apply a pressure of 3 ton/cm² or more), for example, in order to enhance the packing density of the positive electrode active material, in this case, breaks 101 easily occur in the positive electrode active material particles 100 as shown in FIG. 3.

It is thus an advantage of the present invention to provide a positive electrode for a non-aqueous electrolyte secondary battery that causes little particle breakage even in the case of an enhanced packing density of the positive electrode active material, and is thereby capable of accomplishing good cycle characteristics.

### Solution to Problem

A positive electrode for a non-aqueous electrolyte secondary battery according to the present invention comprises a positive electrode current collector having a Young's modulus of 6.5 N/mm² or less, and a positive electrode active material layer formed on the positive electrode current collector and comprising a positive electrode active material particle of which a single particle has a compression breakage strength of 200 MPa or more.

### Advantageous Effects of Invention

According to the present invention, there can be provided a positive electrode having an enhanced packing density of the active material and suppressed particle breakage of the active material, and a non-aqueous electrolyte secondary battery using the positive electrode.

### BRIEF DESCRIPTION OF DRAWINGS

FIG. 1 is a cross section showing a non-aqueous electrolyte secondary battery which is an example of the embodiment of the present invention.

FIG. 2 is a cross section showing a positive electrode which is an example of the embodiment of the present invention.

FIG. 3 is a cross section showing a conventional positive electrode.

### DESCRIPTION OF EMBODIMENT

Hereinafter, an example of the embodiment of the present invention will be described in detail, referring to the drawings.

The drawings referred to in the embodiment are schematically drawn and the dimension ratios of the components drawn in the drawings and the like may be different from those of the actual articles in some cases. The specific dimension ratios and the like should be determined taking the following description into consideration.

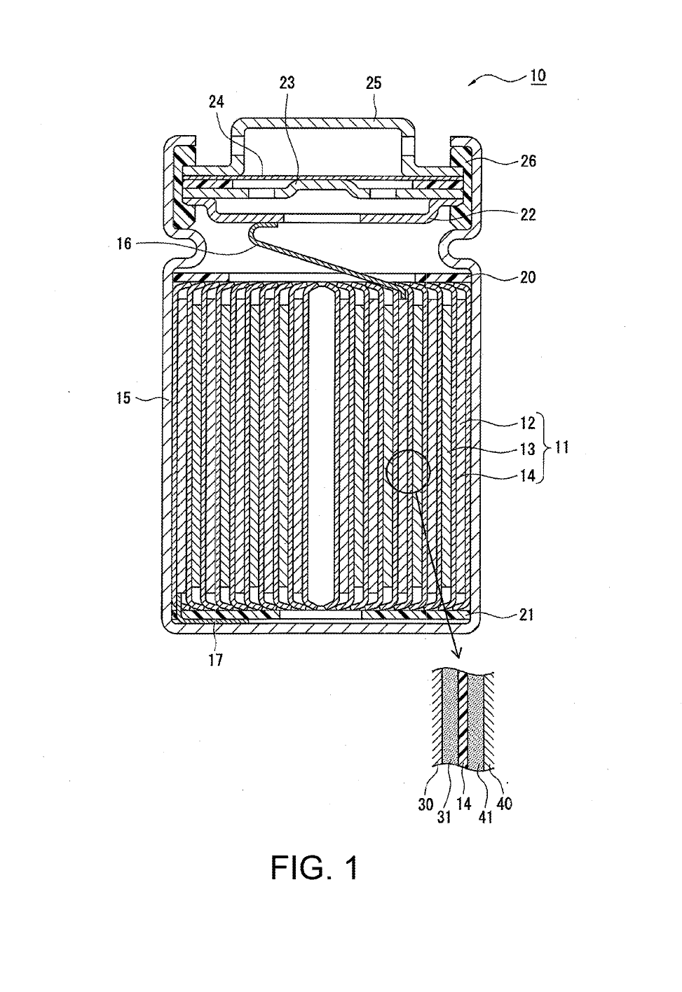

As shown in FIG. 1, a non-aqueous electrolyte secondary battery 10 (hereinafter, referred to as “secondary battery 10”) which is an example of the embodiment of the present invention is a cylindrical battery comprising an electrode body 11 formed of a positive electrode 12 and a negative electrode 13 wound with a separator 14 interposed therebetween and a non-aqueous electrolyte (not shown). The following description will be made on the secondary battery 10 in which the electrode body 11 has a wound structure and has a cylindrical appearance, but the structure of the electrode body and the appearance shape are not limited thereto. The structure of the electrode body may be, for example, a stacked type in which positive electrodes and negative electrodes are alternately stacked with separators interposed therebetween. In addition, the appearance shape of the battery may be a square shape or a coin shape.

The secondary battery 10 comprises the electrode body 11 attached with a positive electrode lead 16 and a negative electrode lead 17, respectively, and a battery case 15 containing the electrolyte. The battery case 15 is, for example, a cylindrical bottomed container made of a metal. In the present embodiment, the negative electrode lead 17 is connected to the inner bottom part of the battery case 15 and the battery case 15 is also used as a negative electrode external terminal. It is to be noted that the battery case 15 is not limited to a hard container made of a metal and may be formed of a laminated packaging material.

In the secondary battery 10, electrical insulation plates 20 and 21 are provided on the top and bottom of the electrode body 11. A filter 22, an inner cap 23, a valve element 24, and a positive electrode external terminal 25 are provided above the electrical insulation plate 20 in this order. These respective members are disposed so as to integrally cover the opening of the battery case 15. Then, a gasket 26 is provided in the gaps between the peripheral edges of the respective members and the battery case 15, thereby sealing the inside of the battery case 15. The positive electrode lead 16 upwardly extends through a hole in the electrical insulation plate 20 and is connected to the filter 22 by means of welding or the like. The negative electrode lead 17 downwardly extends through a hole in the electrical insulation plate 21 and is connected to the battery case 15 by means of welding or the like.

### [Positive Electrode 12]

The positive electrode 12 has a positive electrode current collector 30 and a positive electrode active material layer 31 formed on the current collector. The positive electrode active material layers 31 are preferably formed on the both surfaces of the positive electrode current collector 30, respectively. The thickness of the positive electrode current collector 30 is, for example, from 10 μm to 40 μm. The thickness of the positive electrode active material layers 31 is, for example, from 20 μm to 100 μm.

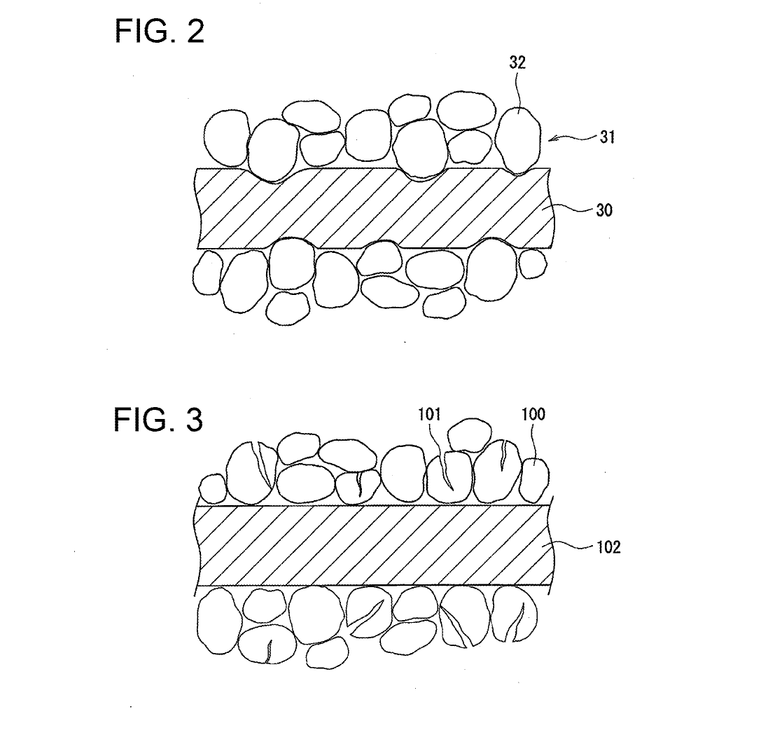

As shown in FIG. 2, positive electrode active material particles 32 contained in the positive electrode active material layer 31 bite into the positive electrode current collector 30 in the positive electrode 12. The positive electrode active material particles 32 are pressed into the positive electrode current collector 30 in the rolling process and some of the respective particles, for example, are embedded into the positive electrode current collector 30. Therefore, adhesion between the positive electrode current collector 30 and the positive electrode active material layer 31 is enhanced (peel strength is high), thereby giving good cycle characteristics also in terms of this point. Such a constitution can be attained by a synergistic effect between the hard positive electrode active material particles 32 and the flexible positive electrode current collector 30, as described below in detail.

As the positive electrode current collector 30, a thin film sheet having electrical conductivity can be used, particularly metal foil or alloy foil, or a film having a metallic surface layer or the like which is stable in the potential range of the positive electrode 12. Preferably, the metal constituting the positive electrode current collector 30 is one mainly composed of aluminum, e.g., aluminum or an aluminum alloy. Examples of the aluminum alloy may include alloys containing aluminum and iron (0.5 wt % to 5 wt %). Preferably, the content of the element other than aluminum in the alloy is 5 wt % or less. Preferably, the thickness of the positive electrode current collector 30 is approximately from 5 μm to 40 μm, and more preferably approximately from 10 μm to 20 μm in terms of current collecting characteristics, mechanical strength or the like.

The positive electrode current collector 30 has higher flexibility than that of the conventional current collectors and has a Young's modulus of 6.5 N/mm² or less. Preferably, the Young's modulus is from 1 N/mm² to 4 N/mm², and preferably from 1 N/mm² to 3 N/mm². When the Young's modulus of the positive electrode current collector 30 is within this range, the breakage of the positive electrode active material particles 32 can be highly suppressed, thereby giving better cycle characteristics. The positive electrode active material layer 31 is, for example, rolled under a high pressure in order to enhance the packing density of the positive electrode active material particle 32, and at this time, the positive electrode current collector 30 having high flexibility absorbs the impact applied to the positive electrode active material particles 32. It is then possible to attain the electrode structure where the positive electrode active material particles 32 bite into the positive electrode current collector 30.

It is to be noted that “Young's modulus” corresponds to a slope of a linear part on a stress-strain curve in which a vertical axis indicates stresses and a horizontal axis indicates strains (tensile elongations). A smaller Young's modulus represents higher stretchability and higher flexibility. Specifically, the Young's modulus can be determined by extracting the data from 0% to 0.3% of elongation at every 0.05% interval and calculating the slope. The stress-strain curve of the positive electrode current collector 30 can be determined by a tensile test. The tensile test can be performed according to JIS 22241 (corresponding international standard: ISO 6892-1) by using, for example, No. 13B specimen.

A suitable method for enhancing the flexibility of the positive electrode current collector 30 is use of an aluminum alloy containing approximately from 0.5 wt % to 5 wt % of iron for the material constituting the current collector, and more preferably heating and annealing the aluminum alloy. The Young's modulus of the positive electrode current collector 30 can be adjusted by controlling the heating temperature or the heating period of time. Preferably, the heating temperature is 150° C. to 300° C., more preferably 180° C. to 280° C., and particularly preferably 200° C. to 260° C. The heating period of time varies depending on the heating temperature, but is preferably approximately from 0.5 second to 10 seconds, for example. Examples of the heating techniques may include contact heating using a heat bar, a heat block or the like and non-contact heating using a laser, a heater or the like.

The positive electrode active material layer 31 preferably contains an electrically conductive material and a binder (not shown) in addition to the positive electrode active material particle 32. The positive electrode active material particle 32 is composed of a lithium-containing transition metal oxide. Preferably, the lithium-containing transition metal oxide has a composition represented by a general formula:

LiNiₓCo_{y}M_{(1-x-y)}O₂

where, M represents at least one metal element, 0.3≦x<1.0, and 0<y≦0.5. Suitable specific examples of the lithium-containing transition metal oxide include LiNi_{0.35}CO_{0.35}M_{0.3}O₂ and LiNi_{0.5}Co_{0.2}M_{0.3}O₂ of the layered rock-salt type. The latter is particularly suitable in terms of cost saving, attaining higher capacity and the like. It is to be noted that preferably, the calcination temperature is low and Li is excessively added in a certain extent in order that the x indicating the composition ratio of Ni satisfies 0.3≦x<1.0 and the layered rock-salt phase is obtained as a stable phase.

Preferably, the metal element M includes manganese (Mn) from the point of view of material cost, safety and the like. In addition, the metal element M may include a metal element other than Mn. Examples of the other metal elements may include magnesium (Mg), zirconium (Zr), molybdenum (Mo), tungsten (W), aluminum (Al), chromium (Cr), vanadium (V), cerium (Ce), titanium (Ti), iron (Fe), potassium (K), gallium (Ga) and indium (In). Preferably, the metal element M includes at least one selected from these other metal elements in addition to Mn, and particularly preferably includes Al for reasons of thermal stability and the like. Preferably, Al is included at approximately 3% by mass based on the total weight of Ni, Co and metal elements M.

The lithium-containing transition metal oxide can be prepared by, for example, ion-exchanging Na in a sodium-containing transition metal oxide with Li. Examples of the methods for the above-described ion exchange may include a technique of adding a molten salt bed of at least one lithium salt selected from the group consisting of lithium nitrate, lithium sulfate, lithium carbonate, lithium hydroxide, lithium iodide, lithium bromide, and lithium chloride to the sodium-containing transition metal oxide. In addition to this, the methods include a technique of immersing the sodium-containing transition metal oxide into a solution containing the at least one lithium salt.

The positive electrode active material particles 32 are secondary particles formed of aggregated primary particles composed of the above-described lithium-containing transition metal oxide. A primary particle refers to a crystallite, which is the largest aggregation that may be regarded as a single crystal, and a secondary particle may be expressed as a particle formed of the aggregated crystallites.

The hardness of the positive electrode active material particle 32 can be evaluated by a compression breakage strength of single particle thereof. The hardness of the positive electrode active material particle 32 stands for mutual cohesion between the crystallites composing the particle. The compression breakage strength (St) is calculated according to the expression:

St=2.8P/πd²

where, P is a load applied to the particle at the time of compression breakage, and d is a particle diameter, described in Journal of the Mining and Metallurgical Institute of Japan, vol. 81, No. 932, p. 1024-1030 (December, 1965). Since the calculation for the compression breakage strength (St) includes division by the square of the particle diameter, the compression breakage strength (St) significantly depends on the particle diameter, and therefore the smaller the particle is, the larger the resultant compression breakage strength (St) is. Accordingly, the compression breakage strength (St) is preferably defined as that at a specified particle diameter. It is to be noted that the load P can be determined by using a compression testing machine (for example, Micro Compression Tester MCT-W201, Shimadzu Corporation)

The compression breakage strength of a single particle is 200 MPa or more, and preferably 300 MPa or more. In addition, the compression breakage strength of a single particle is preferably 500 MPa or less. When the compression breakage strength of the positive electrode active material particle 32 is within this range, the breakage of the positive electrode active material particles 32 can be highly suppressed and better cycle characteristics can be attained. The positive electrode active material particles 32 bite into the positive electrode current collector 30 having high flexibility without causing breakage in the process of rolling the positive electrode active material layer 31.

The above-described electrically conductive material is used in order to enhance the electrical conductivity of the positive electrode active material layer. The electrically conductive material includes carbon materials such as carbon black, acetylene black, Ketjen black and graphite. These may be used singly or in combinations of two or more thereof. The above-described binder is used in order to keep a good contacting state between the positive electrode active material and the electrically conductive material, and to enhance bindability of the positive electrode active material and the like to the surface of the positive electrode current collector. As the binder, polytetrafluoroethylene (PTFE), polyvinylidene fluoride (PVdF), modified materials thereof or the like are used. The binder may be used together with a thickener such as carboxymethyl cellulose (CMC) or polyethylene oxide (PEO).

Preferably, the charge finish potential of the positive electrode 12 is 4.25V or more (vs. Li/Li⁺), and more preferably 4.40 V or more (vs. Li/Li⁺) in terms of attaining higher capacity. The upper limit of the charge finish potential of the positive electrode 12 is not particularly limited, but is preferably 4.8 V (vs. Li/Li⁺) or less from the viewpoint of suppressing decomposition of the non-aqueous electrolyte or the like.

### [Negative Electrode 13]

The negative electrode 13 has a negative electrode current collector 40 and a negative electrode active material layer 41 formed on the current collector. The negative electrode active material layers 41 are preferably formed on the both surfaces of the negative electrode current collector 40, respectively. The thickness of the negative electrode current collector 40 is, for example, approximately from 5 μm to 20 μm. The thickness of the negative electrode active material layers 41 is, for example, from 20 μm to 100 μm.

As the negative electrode current collector 40, a thin film sheet having electrical conductivity can be used, particularly metal foil or alloy foil, or a film having a metallic surface layer or the like which is stable in the potential range of the negative electrode 13. Preferably, the metal constituting the negative electrode current collector 40 is one mainly composed of copper.

Preferably, the negative electrode active material layers 41 contain, for example, a binder in addition to the negative electrode active material capable of occluding and releasing lithium ions. Examples of the negative electrode active material may include natural graphite, artificial graphite, lithium, silicon, carbon, tin, germanium, aluminum, lead, indium, gallium, lithium titanate, and alloys and mixtures thereof. PTFE or the like may be used for the binder, similarly to the case of the positive electrode, but styrene-butadiene copolymer (SBR), a modified material thereof, or the like, is preferably used. The binder may be used together with a thickener such as CMC.

### [Separator 14]

For the separator 14, a porous sheet having ion permeability and insulating properties is used. Specific examples of the porous sheet may include microporous thin films, woven fabric and non-woven fabric. A suitable material for the separator 14 is cellulose or a polyolefin-based resin such as polyethylene or polypropylene. The thickness of the separator 14 is, for example, from 10 μm to 40 μm.

### [Non-Aqueous Electrolyte]

The non-aqueous electrolyte contains a non-aqueous solvent and an electrolyte salt dissolved in the non-aqueous solvent. The non-aqueous electrolyte is not limited to a liquid electrolyte (non-aqueous electrolyte liquid), but may be a solid electrolyte using a gelatinous polymer or the like. For the non-aqueous solvent, for example, esters, ethers, nitriles such as acetonitrile, amides such as dimethylformamide, or mixed solvents of two or more thereof can be used. The non-aqueous solvent may contain a halogen-substituted substance which is formed by substituting a hydrogen atom of each of these solvents with a halogen atom such as fluorine. Preferably, the halogen-substituted substance is a fluorinated cyclic carbonate or a fluorinated linear carbonate, and more preferably those two are used in a mixture.

Examples of the above-described esters include cyclic carbonates such as ethylene carbonate, propylene carbonate and butylene carbonate; linear carbonates such as dimethyl carbonate, methylethyl carbonate, diethyl carbonate, methylpropyl carbonate, ethylpropyl carbonate and methylisopropyl carbonate, and carboxylic acid esters such as methyl acetate, ethyl acetate, propyl acetate, methyl propionate, ethyl propionate and γ-butylolactone.

Examples of the above-described ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole and crown ethers; and linear ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl.

Preferably, the above-described electrolyte salt is a lithium salt. Examples of the lithium salt include LiPF₆, LiBF₄, LiAsF₆, LiClO₄, LiCF₃SO₃, LiN(FSO₂)₂, LiN(C₁F₂₁₊₁SO₂) (CₘF₂ₘ₊₁SO₂) (1 and m are integers of 1 or more, respectively), LiC (CₚF₂ₚ₊₁SO₂) (C_{q}F_{2q+1}SO₂) (CᵣF₂ᵣ₊₁SO₂) (p, q, and r are integers of 1 or more, respectively), Li[B(C₂O₄)₂](bis(oxalato)lithium borate (LiBOB)), Li[B(C₂O₄)F₂], Li[P(C₂O₄)F₄], Li[P(C₂O₄)₂F₂], and mixtures of two or more thereof.

### EXAMPLES

Hereinafter, the present invention will be further illustrated based on Examples, but the present invention is not intended to be limited to these Examples.

### Example 1

### Preparation of Positive Electrode

Sodium nitrate (NaNO₃), nickel oxide (II) (NiO), cobalt oxide (II, III) (Co₃O₄), and manganese oxide (III) (Mn₂O₃) were mixed together so as to give Na_{0.95}Ni_{0.5}CO_{0.2}Mn_{0.3}O₂ (charge composition). Then, the mixture was kept at 900° C. for 10 hours to give the sodium-containing transition metal oxide.

To 5 g of the above-described sodium-containing transition metal oxide, was added a five time-equivalent (25 g) molten salt bed which had been prepared by mixing lithium nitrate (LiNO₃) and lithium hydroxide (LiOH) so as to make a rate thereof 61:39 in mol %. Then, the resultant mixture was kept at 200° C. for 10 hours to ion-exchange a portion of the sodium ions in the sodium-containing transition metal oxide with the lithium ions. In addition, the resultant material after the ion exchange was washed with water to give a lithium-containing transition metal oxide. The lithium-containing transition metal oxide was used as a positive electrode active material particle Al.

The crystal structure of the above-described lithium-containing transition metal oxide was identified by the powder X-ray diffraction method (using a powder X-ray diffractometer RINT2200 (source: Cu-Kφ), Rigaku Corporation). Consequently, the crystal structure thereof was assigned to that of the layered rock-salt type. The composition of the lithium-containing transition metal oxide was calculated by ICP emission analysis (using an ICP emission spectrophotometer iCAP6300, Thermo Fisher Scientific Inc.). Consequently, the composition was Li_{0.98}Ni_{0.5}CO_{0.2} Mn_{0.3}O₂.

The compression breakage strength (St) of a single particle of the positive electrode active material particle A1 (the above-described lithium-containing transition metal oxide) was determined by measuring the load P applied to the particle at the time of compression breakage using a compression testing machine (Micro Compression Tester MCT-W201, Shimadzu Corporation) and calculating the St according to the above-described expression St=2.8P/πd². Consequently, the St was 333.8 MPa. This value was obtained by measuring the load P for five particles and employing the average value thereof.

The positive electrode active material particle A1 (92% by mass), carbon powder (5% by mass) as the electrically conductive material, and polyvinylidene fluoride powder (3% by mass) as the binder were mixed together, and then the resultant mixture was mixed with an N-methyl-2-pyrrolidone (NMP) solution to prepare slurry. This slurry was applied to both surfaces of a positive electrode current collector B1 by the doctor blade method to form positive electrode active material layers. Then, the layers were compressed using a compression roller, the compressed material was cut so that the short sides were 55 mm and the long sides were 600 mm, and then a positive electrode lead was attached to give a positive electrode.

Aluminum alloy foil (alloy No. 8021; Al 98.5 wt %, Fe 1.5 wt %) having a thickness of 15 μm was used for the positive electrode current collector B1. Annealing of the positive electrode current collector was carried out using a heat block under conditions of 240° C. for 5 seconds. The Young's modulus of the positive electrode current collector B1 was determined from a stress-strain curve measured by a tensile test (JIS 22241) as described above. Consequently, the Young's modulus of the positive electrode current collector B1 was 1.4 N/mm².

### [Preparation of Negative Electrode]

A mixture of three kinds of materials of natural graphite, artificial graphite, and artificial graphite surface-coated with amorphous carbon was used for the negative electrode active material. The negative electrode active material (98% by mass), SBR (1% by mass) as the binder, and CMC (1% by mass) as the thickener were mixed together, and then the resultant mixture was mixed with water to prepare slurry. This slurry was applied to both surfaces of a current collector made of copper having a thickness of 10 μm by the doctor blade method to form negative electrode active material layers. Then, the layers were compressed using a compression roller to a predetermined density, the compressed material was cut to have 57 mm as a shorter side and 620 mm as a longer side, and then a negative electrode lead was attached to give a negative electrode.

### [Preparation of Non-Aqueous Electrolyte Liquid]

LiPF₆ was dissolved as the electrolyte salt in a non-aqueous solvent which had been prepared by mixing ethylene carbonate (EC) and diethyl carbonate (DEC) in an equivalent volume at a concentration of 1.6 mol/L to prepare a non-aqueous electrolyte liquid.

### [Manufacture of Battery]

A wound type electrode body shown in FIG. 1 was manufactured using the positive electrode, the negative electrode and the non-aqueous electrolyte liquid described above, and a separator. A polyethylene micro porous film having a thickness of 16 μm was used for the separator. This electrode body was accommodated in a cylindrical battery case made of steel having a diameter of 18 mm and a height of 650 mm, and the negative electrode lead and the positive electrode lead were welded to an inner bottom of the battery case and to the filter, respectively. Subsequently, the non-aqueous electrolyte liquid was poured into the battery case through opening thereof, and then the opening was sealed to give a test cell C1 which was a non-aqueous electrolyte secondary battery. The rated capacity of the test cell C1 was 1200 mAh and setup was done as negative electrode capacity/positive electrode capacity=1.1 (the same applies hereinafter).

### [Evaluation of Peel Strength of Positive Electrode Active Material Layer]

The evaluation procedure is as follows.

It is to be noted that with higher peel strength of the positive electrode active material layer, better charge-discharge cycle characteristics of the non-aqueous electrolyte secondary battery can be obtained (high peel strength≈excellent in cycle characteristics).

(1) One surface of the positive electrode active material layer is peeled, and then the positive electrode is fixed with the positive electrode active material layer on the opposite surface facing downward.
(2) A part of the positive electrode current collector is peeled from the fixed positive electrode, and then this part is bent at an angle of 90° to the positive electrode.
(3) The positive electrode current collector bent at an angle of 90° is pulled with a universal tester to determine the peel strength.

### [Evaluation of Particle Breakage of Positive Electrode Active Material Particle Al]

The evaluation procedure is as follows.

(1) The positive electrode is subjected to resin embedding treatment, cut, and then the cross section is polished.
(2) The polished surface is observed by a scanning electron microscope (SEM) to confirm breakage of the positive electrode active material particles.

### Example 2

A test cell C2 was manufactured in the same manner as that for Example 1 except that the positive electrode current collector B1 was not subjected to annealing.

### Comparative Example 1

A test cell Z1 was manufactured in the same manner as that for Example 2 except for using, as a positive electrode active material particle X1, a positive electrode active material having a compression breakage strength of 89.2 MPa obtained by changing the temperature for heating the mixture in the preparation of the positive electrode active material A1 to 800° C.

### Comparative Example 2

A test cell Z2 was manufactured in the same manner as that for Example 2 except for using, as a positive electrode active material particle X2, a positive electrode active material having a compression breakage strength of 163.2 MPa obtained by changing the temperature for heating the mixture in the preparation of the positive electrode active material A1 to 850° C.

### Comparative Example 3

A test cell Z3 was manufactured in the same manner as that for Example 1 except for using a positive electrode current collector Y3 consisting of aluminum alloy foil (alloy No. 3003; Al 98 wt %, Fe 0.6 wt %, Mn 1.4%, elongation 0.3%) in place of the positive electrode current collector B1.

Table 1 shows compression breakage strengths of the positive electrode active material particles in respective Examples and respective Comparative Examples, the Young's moduluses of the positive electrode current collectors in respective Examples and current collector respective Comparative Examples, and the results of the above-described evaluations.

TABLE 1

| | Positive electrode | | | |
|---|---|---|---|---|
| | active material | Positive electrode | | |
| | compression | current collector | | Peel |
| | breakage strength | Young' modulus | Particle | strength |
| | (MPa) | (N/mm²) | breakage | (N/mm) |
| Example 1 | 333.8 | 1.4 | None | 27.3 |
| Example 2 | 333.8 | 5.3 | None | 16.1 |
| Comparative | 89.2 | 5.3 | Present | 3.66 |
| Example 1 | | | | |
| Comparative | 163.2 | 5.3 | Present | 7.30 |
| Example 2 | | | | |
| Comparative | 333.8 | 7.9 | Present | 8.75 |
| Example 3 | | | | |

As is clear from the results shown in Table 1, regarding Examples 1 and 2 using the soft positive electrode current collectors having a Young's modulus of 6.5 N/mm² or less and the hard positive electrode active material having a compression breakage strength of 200 MPa or more, the positive electrode current collector absorbs the impact applied to the positive electrode active material at the time of the rolling, thereby suppressing the particle breakage of the positive electrode active material, and a part of respective positive electrode active material particles bite into the positive electrode current collector, thereby enhancing the peel strength. On the other hand, regarding Comparative Examples 1 and 2 using the soft positive electrode current collectors having a Young's modulus of 6.5 N/mm² or less and the soft positive electrode active material having a compression breakage strength less than 200 MPa, the positive electrode active material is soft, thereby causing the particle breakage of the positive electrode active material due to the impact at the time of the rolling and the positive electrode active material particles bite into the positive electrode current collector to a lesser degree, thereby lowering the peel strength compared with Example 2. In addition, regarding Comparative Example 3 using the hard positive electrode current collector having a Young's modulus exceeding 6.5 N/mm² and the hard positive electrode active material having a compression breakage strength of 200 MPa or more, the positive electrode current collector is hard and hardly absorbs the impact at the time of the rolling, as a result of which the impact applied to the positive electrode active material is large and the particle breakage occurs, and there is no biting of the positive electrode active material particles into the positive electrode current collector, thereby lowering the peel strength.

From the results described above, good cycle characteristics can be attained by using the soft positive electrode current collector having a Young's modulus of 6.5 N/mm² or less and the hard positive electrode active material having a compression breakage strength of 200 MPa or more, since the positive electrode current collector having high flexibility absorbs the impact applied to the positive electrode active material at the time of the rolling, thereby suppressing the particle breakage and a part of the respective positive electrode active material particles bite into the positive electrode current collector, thereby enhancing the peel strength.

### REFERENCE SIGNS LIST

10 non-aqueous electrolyte secondary battery, 11 electrode body, 12 positive electrode, 13 negative electrode, 14 separator, 15 battery case, 16 positive electrode lead, 17 negative electrode lead, 20, 21 electrical insulation plates, 22 filter, 23 inner cap, 24 valve element, 25 positive electrode external terminal, 26 gasket, 30 positive electrode current collector, 31 positive electrode active material layer, 32 positive electrode active material particle, 40 negative electrode current collector, 41 negative electrode active material layer

1. A positive electrode for a non-aqueous electrolyte secondary battery, the electrode comprising:
a positive electrode current collector having a Young's modulus of 6.5 N/mm² or less; and
a positive electrode active material layer formed on the positive electrode current collector and comprising a positive electrode active material particle of which a single particle has a compression breakage strength of 200 MPa or more.

2. The positive electrode for a non-aqueous electrolyte secondary battery according to claim 1,
wherein the Young's modulus of the positive electrode current collector is from 1 N/mm² to 4 N/mm².

3. The positive electrode for a non-aqueous electrolyte secondary battery according to claim 1,
wherein the compression breakage strength of the positive electrode active material particle is 500 MPa or less.

4. The positive electrode for a non-aqueous electrolyte secondary battery according to claim 1,
wherein the positive electrode active material particle has a composition represented by a general formula:
LiNiₓCo_{y}M_{(1-x-y)}O₂
where, M represents at least one metal element, 0.3≦x<1.0, and 0<y≦0.5, and
wherein the metal element M is at least manganese (Mn), and comprises at least one metal element selected from magnesium (Mg), zirconium (Zr), molybdenum (Mo), tungsten (W), aluminum (Al), chromium (Cr), vanadium (V), cerium (Ce), titanium (Ti), iron (Fe), potassium (K), gallium (Ga) and indium (In).

5. A non-aqueous electrolyte secondary battery comprising:
the positive electrode for a non-aqueous electrolyte secondary battery according to claim 1;
a negative electrode; and
a non-aqueous electrolyte.
